(19) United States
(12) Patent Application Publication
(10) Pub. No.: US 2024/0370536 A1
(43) Pub. Date: Nov. 7, 2024

(54) TECHNIQUES FOR AUTHENTICATING USERS DURING COMPUTER-MEDIATED INTERACTIONS

(71) Applicant: NVIDIA CORPORATION, Santa Clara, CA (US)

(72) Inventors: Ekta PRASHNANI, San Jose, CA (US); Orazio GALLO, Santa Cruz, CA (US); Shalini DE MELLO, San Francisco, CA (US); Koki NAGANO, Playa Vista, CA (US); David LUEBKE, Charlottesville, VA (US)

(21) Appl. No.: 18/648,158

(22) Filed: Apr. 26, 2024

Related U.S. Application Data
(60) Provisional application No. 63/500,339, filed on May 5, 2023.

(51) Int. Cl. G06F 21/31; G06T 19/00; G06V 40/20

(52) U.S. Cl. CPC G06F 21/31; G06T 19/006; G06V 40/20

(57) ABSTRACT

Techniques are disclosed herein for authenticating users. The techniques include generating a first fingerprint that represents one or more motions of a first avatar that is driven by a first user, and determining an identity of the first user based on the first fingerprint and a second fingerprint associated with the first user.

### CROSS-REFERENCE TO RELATED APPLICATIONS

This application claims priority benefit of the United States Provisional Patent Application titled, “FINGERPRINTING FOR SYNTHETIC VIDEO PORTRAIT AUTHENTICATION,” filed on May 5, 2023, and having Ser. No. 63/500,339. The subject matter of this related application is hereby incorporated herein by reference.

### GOVERNMENT RIGHTS

This invention was made with government support under Agreement No. HR00112030005 awarded by DARPA. The government has certain rights in the invention.

### BACKGROUND

### Technical Field

Embodiments of the present disclosure relate generally to user authentication and computer science and, more specifically, to techniques for authenticating users during computer-mediated interactions.

### Description of the Related Art

In computer-mediated interactions, an avatar typically is controlled, or “driven,” by a user to interact with one or more other users. In this type of context, an avatar is an electronic representation of a user that can be manipulated (controlled or driven) by the user. For example, rather than sharing video and audio of a user during a videoconference, the user could choose to share an avatar that is generated from the video and audio using artificial intelligence (AI) synthesis techniques. In such cases, the avatar could be controlled to perform actions that are similar to the actions performed by the user in the video and audio.

One drawback of computer-mediated interactions is that, because a given users presents an avatar to one or more other users, those other users cannot see the person who is actually controlling the avatar. Accordingly, the other users have no direct means of ascertaining the identity of the user who is controlling the avatar. In addition, no effective techniques currently exist for authenticating a user who controls an avatar during a computer-mediated interaction. The inability to identify and/or authenticate the identities of users during computer-mediated interactions enables nefarious users to impersonate other users by controlling the avatars of those other users. Also, the inability to identify and/or authenticate the identities of users creates safety risks for children and other vulnerable users.

As the foregoing illustrates, what is needed in the art are more effective techniques for verifying user identities during computer-mediated interactions.

### SUMMARY

Some embodiments of the present disclosure set forth a computer-implemented method for authenticating users. The method includes generating a first fingerprint that represents one or more motions of a first avatar that is driven by a first user. The method further includes determining an identity of the first user based on the first fingerprint and a second fingerprint associated with the first user.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques enable the identities of users who control avatars during computer-mediated interactions to be authenticated. The authentication of user identities can improve security, trust, and safety during computer-mediated interactions. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a more detailed illustration of one of the computing devices of FIG. 1, according to various embodiments;

FIG. 3 is a more detailed illustration of the client applications and the server application of FIG. 1, according to various embodiments;

FIG. 4 is a more detailed illustration of the authentication module of FIG. 3, according to various embodiments;

FIG. 5 illustrates how to authenticate exemplar user that drive avatars, according to various embodiments;

FIG. 6 illustrates how exemplar training data is generated for training the machine learning model of FIG. 4, according to various embodiments;

FIG. 7 is a more detailed illustration of the client applications and the server application of FIG. 1, according to various other embodiments;

FIG. 8 is a more detailed illustration of the client applications of FIG. 1, according to various other embodiments;

FIG. 9 is a more detailed illustration of the client applications of FIG. 1, according to various other embodiments;

FIG. 10 is a flow diagram of method steps for authenticating a user during a computer-mediated interaction, according to various embodiments;

FIG. 11 is a flow diagram of method steps for generating a fingerprint that represents motions of a user during an onboarding process, according to various embodiments; and

FIG. 12 is a flow diagram of method steps for training a machine learning to generate fingerprints that represent motions of users, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for authenticating user identities during computer-mediated interactions. Given video data that includes an avatar being driven by a user, an authorization module of a client or server application generates feature data for the avatar within a window of frames. The authorization module processes the feature data using a trained machine learning model to generate a fingerprint representing motions of the avatar within the window of frames, regardless of the appearance of the avatar, which is generally not a reliable indicator of who is “behind” the avatar. The authorization module authenticates the identity of the user driving the avatar by comparing the fingerprint representing motions of the avatar with stored fingerprints representing motions of users who are authorized to drive the avatar. The user is an authorized user if the fingerprint representing motions of the avatar is within a threshold distance of one of the stored fingerprints representing motions of authorized users. In some embodiments, the machine learning model used to generate the fingerprint can be trained using (1) training data that includes self-reenactment video data in which avatars having particular identities are driven by video data of users having the same identities and cross-reenactment videos in which avatars having particular identities are driven by video data of users having different user identities; and (2) a dynamic contrastive loss function that pulls together, within an embedding space, fingerprints generated by the machine learning model for video data in which avatars are controlled by users having the same identity, and pushes apart, within the embedding space, fingerprints generated by the machine learning model for video data in which avatars are controlled by users having different identities.

The techniques disclosed herein for verifying identities of users who drive avatars have many real-world applications. For example, those techniques could be used to verify the identities of users who control avatars in a videoconference. As another example, those techniques could be used to verify the identities of users who control avatars within an extended reality (XR) environment, such as the metaverse. XR environments include immersive virtual or augmented environments in which users can interact with virtual three-dimensional (3D) objects as if the objects were real. Examples of XR environments include augmented reality (AR) environments and virtual reality (VR) environments. As used herein, AR refers to a view of the physical environment with an overlay of one or more computer-generated graphical elements, including mixed reality (MR) environments in which physical objects and computer-generated elements can interact. As used herein, VR refers to a virtual environment that includes computer-generated elements.

The above examples are not in any way intended to be limiting. As persons skilled in the art will appreciate, as a general matter, the techniques for verifying user identities can be implemented in any suitable application.

### System Overview

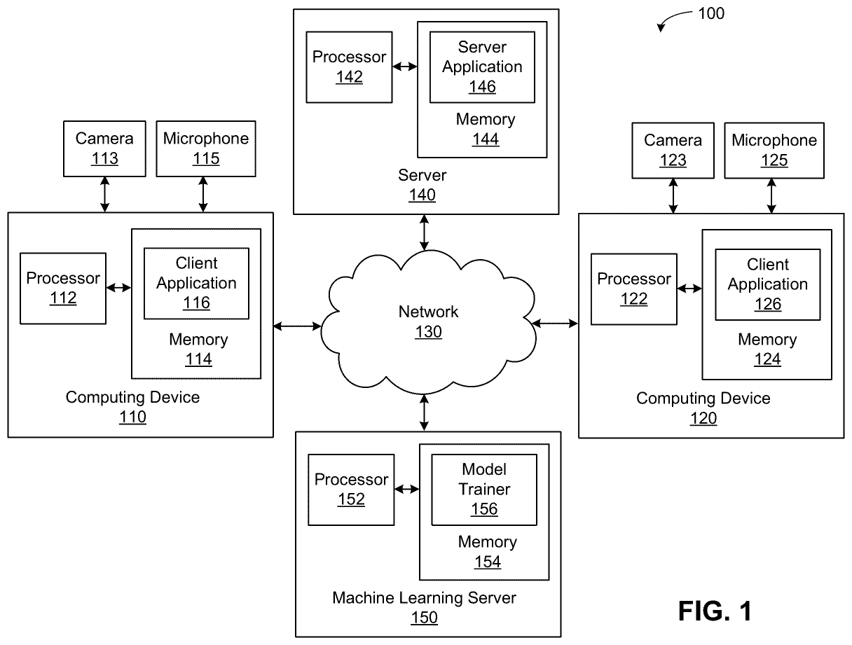

FIG. 1 illustrates a system 100 configured to implement one or more aspects of the various embodiments. As shown, the system 100 includes a server device 140 (also referred to herein as “server 140”), a machine learning server 150, two computing devices 110 and 120, a camera 113 and a microphone 115 that are connected to the computing device 110, and a camera 123 and a microphone 125 that are connected to the computing device 120. Illustratively, the computing devices 110 and 120, the server 140, and the machine learning server 150 are in communication over a network 130. In some embodiments, the network 130 can be a wide area network (WAN) such as the Internet, a local area network (LAN), or any other technically feasible network. In some embodiments, the server 140 and the machine learning server 150 are server machines operating in a data center or a cloud computing environment that provides scalable computing resources as a service over a network.

As shown, a client application 116 executes on a processor 112 of the computing device 110 and is stored in a system memory 114 of the computing device 110. The processor 112 receives user input from input devices, such as a keyboard or a mouse. In operation, the processor 112 is the master processor of the computing device 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The system memory 114 of the computing device 110 stores content, such as software applications and data, for use by the processor 112 and the GPU. The system memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the computing device 110 shown herein is illustrative and that variations and modifications are possible. For example, the number of processors 112, the number of GPUs, the number of system memories 114, and the number of applications included in the system memory 114 can be modified as desired. Further, the connection topology between the various units in FIG. 1 can be modified as desired. In some embodiments, any combination of the processor 112, the system memory 114, and a GPU can be replaced with any type of virtual computing system, distributed computing system, or cloud computing environment, such as a public, private, or a hybrid cloud.

A client application 126 executes on a processor 122 of the computing device 120 and is stored in a system memory 124 of the computing device 120. Further, a server application 146 executes on a processor 142 of the server 140 and is stored in a system memory 144 of the server 140. In addition, a model trainer 156 executes on a processor 152 of the machine learning server 150 and is stored in a system memory 154 of the machine learning server 150. In some embodiments, the processors 122, 142, and 152 and the system memories 124, 144, and 152 of the computing device 120, the server 140, and the machine learning server 150, respectively, are similar to the processor 112 and the system memory 114, respectively, of the computing device 110.

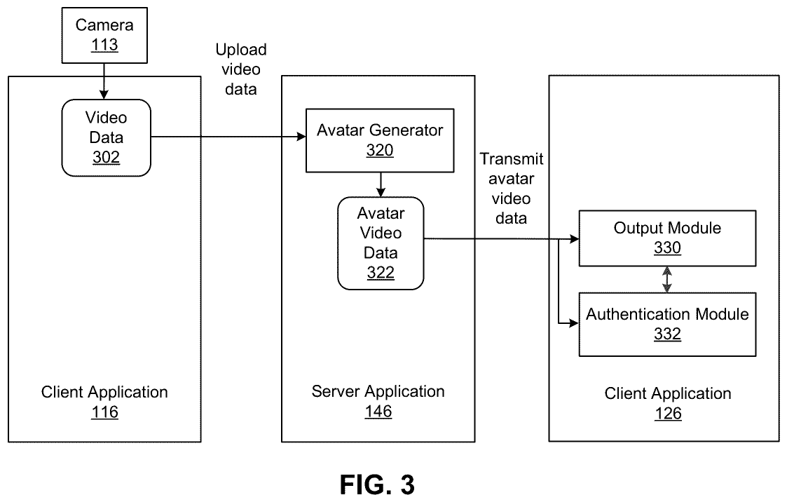

In some embodiments, the client application 116 executing on the computing device 110, the client application 126 executing on the computing device 120, and the server application 146 executing on the server 140 facilitate a live, computer-mediated interaction between a user of the computer device 110 and a user of the computer device 120. For example, the client applications 116 and 126 could be videoconferencing clients that facilitate a videoconference in which at least one user controls an avatar to interact with one or more other users. As another example, the client applications 116 and 126 could be XR clients that facilitate interactions within an XR environment in which at least one user controls an avatar. During a computer-mediated interaction, avatars can be transmitted rather than video and audio data of a user for various reasons, such as privacy, beautification filtering, maintaining eye contact during videoconferences, lowering bandwidth usage, translating between languages, etc. In some embodiments, the client application 116, the client application 126, and/or the server application 146 perform techniques to verify the identity of at least one user who controls an avatar during a computer-mediated interaction, as discussed in greater detail below in conjunction with FIGS. 3-11. Although described herein primarily with respect to bidirectional communication in which an avatar is transmitted to from one client application (e.g., client application 116) to another client application (e.g., client application 126), in some embodiments, one-to-many streaming may be used to transmit an avatar from one client application to multiple client applications that verify the identity of a user who controls the avatar during a computer-mediated interaction.

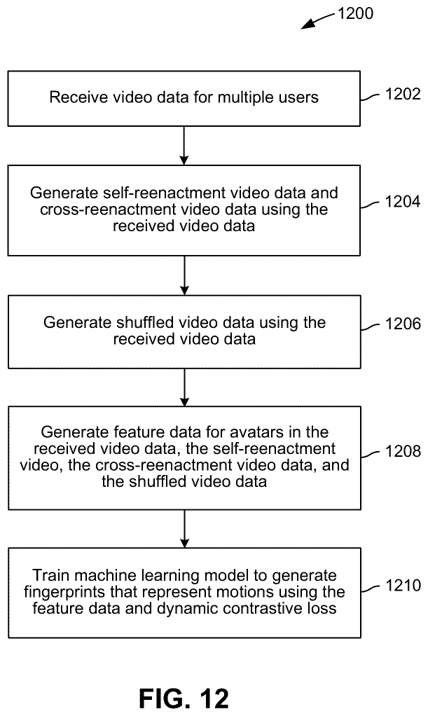

In some embodiments, the model trainer 156 is configured to train one or more machine learning models, including a machine learning model that is trained to generate a fingerprint that represents the motions of an avatar being driven by a user and can be compared with stored fingerprints to authenticate the user. Techniques that the model trainer 156 can employ to train the machine learning model(s) are discussed in greater detail below in conjunction with FIG. 12. Trained machine learning models can be deployed to any suitable applications, such as the client application 116, the client application 126, and/or the server application 146.

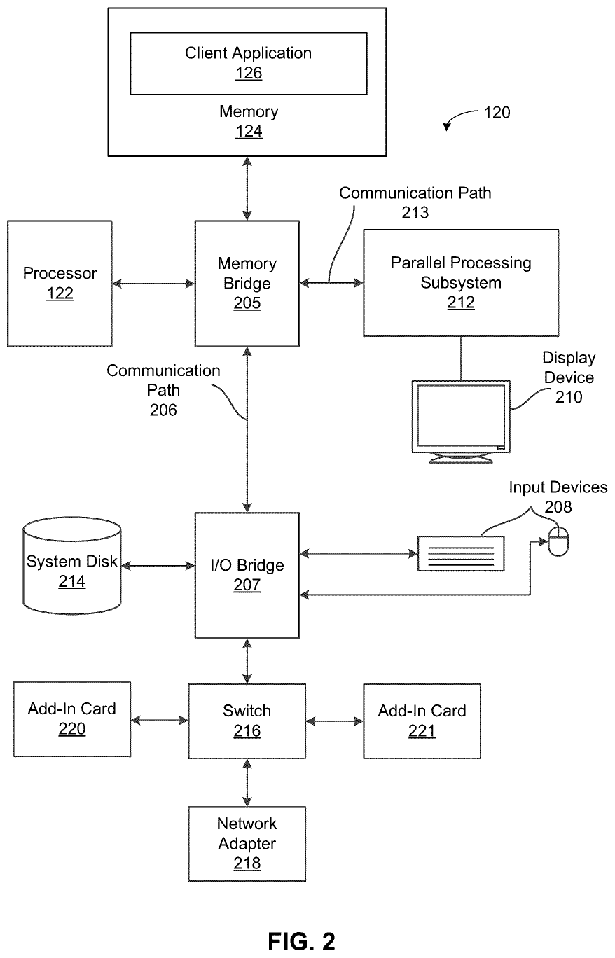

FIG. 2 is a more detailed illustration of the server 140 of FIG. 1, according to various embodiments. As persons skilled in the art will appreciate, the server 140 can be any type of technically feasible computer system, including, without limitation, a server machine, a server platform, a desktop machine, a laptop machine, a hand-held/mobile device, or a wearable device. In some embodiments, the computing devices 110 and 120 and the machine learning server 156 can include similar components as the server 140.

In various embodiments, the server 140 includes, without limitation, the processor 142 and the memory 144 coupled to a parallel processing subsystem 212 via a memory bridge 205 and a communication path 206. Memory bridge 205 is further coupled to an I/O (input/output) bridge 207 via a communication path 206, and I/O bridge 207 is, in turn, coupled to a switch 216.

In some embodiments, the I/O bridge 207 is configured to receive user input information from optional input devices 208, such as a keyboard or a mouse, and forward the input information to the processor 142 for processing via communication the path 206 and the memory bridge 205. In some embodiments, the server 140 may be a server machine in a cloud computing environment. In such embodiments, the server 140 may not have input devices 208. Instead, the server 140 may receive equivalent input information by receiving commands in the form of messages transmitted over a network and received via the network adapter 218. In some embodiments, the switch 216 is configured to provide connections between the I/O bridge 207 and other components of the server 140, such as a network adapter 218 and various add-in cards 220 and 221.

In some embodiments, the I/O bridge 207 is coupled to a system disk 214 that may be configured to store content and applications and data for use by the processor 142 and the parallel processing subsystem 212. In some embodiments, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, memory bridge 205 may be a Northbridge chip, and the I/O bridge 207 may be a Southbridge chip. In addition, the communication paths 206 and 213, as well as other communication paths within server 140, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs), also referred to herein as parallel processors, included within the parallel processing subsystem 212. In some other embodiments, the parallel processing subsystem 212 incorporates circuitry optimized for general purpose and/or compute processing. Again, such circuitry may be incorporated across one or more PPUs included within the parallel processing subsystem 212 that are configured to perform such general purpose and/or compute operations. In some other embodiments, the one or more PPUs included within the parallel processing subsystem 212 may be configured to perform graphics processing, general purpose processing, and compute processing operations. The system memory 144 includes at least one device driver configured to manage the processing operations of the one or more PPUs within the parallel processing subsystem 212. In addition, the system memory 144 includes the server application 146, described above in conjunction with FIG. 1.

In various embodiments, the parallel processing subsystem 212 may be integrated with one or more of the other elements of FIG. 2 to form a single system. For example, the parallel processing subsystem 212 may be integrated with the processor 142 and other connection circuitry on a single chip to form a system on chip (SoC).

In some embodiments, the processor 142 is the master processor of the server 140, controlling and coordinating operations of other system components. In some embodiments, the processor 142 issues commands that control the operation of PPUs. In some embodiments, the communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors (e.g., processor 142), and the number of the parallel processing subsystems 212, may be modified as desired. For example, in some embodiments, the system memory 144 could be connected to the processor 142 directly rather than through the memory bridge 205, and other devices would communicate with the system memory 144 via the memory bridge 205 and the processor 142. In other embodiments, the parallel processing subsystem 212 may be connected to the I/O bridge 207 or directly to the processor 142, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

### Authenticating User Identities During Computer-Mediated Interactions

FIG. 3 is a more detailed illustration of the client applications 116 and 126 and the server application 146 of FIG. 1, according to various embodiments. As shown, the client application 116 receives video data 302 captured by the camera 113 during a live, computer-mediated interaction. The client application 116 can also receive audio data (not shown) acquired by the microphone 115 during the computer-mediated interaction. As described, in some embodiments, the computer-mediated interaction can be, for example, a videoconference or XR environment interaction during which one or more users are represented by avatars controlled by the user(s). Illustratively, the client application 116 uploads the video data 302 to the server application 146 for processing by an avatar generator module 320 (also referred to herein as “avatar generator 320”) that generates avatar video data 322, discussed in greater detail below.

As shown, the server application 146 includes the avatar generator 320. In operation, the avatar generator 320 takes as input the video data 302 of a user, and the avatar generator 320 generates avatar video data 322 that includes one or more video frames of an avatar that moves in a similar manner as the user moves in the video data 302, which can include subtle facial motions of the user. For example, in some embodiments, the avatar video data 322 can be generated by processing the video data 302 via one or more generative machine learning models that output the avatar video data 322. Although described herein primarily with respect to avatar video data that includes an avatar face as a reference example, in some embodiments, any technically feasible avatar can be generated from any suitable data, such as a 3D avatar, a full-body avatar, a voice avatar, or the like, and a unique fingerprint of the generated avatar can be leveraged for verification of authorized use of the avatar.

In some embodiments, the avatar video data 322 can include an avatar that is a realistic representation of an individual. In such cases, the realistic representation can have the same identity as the user in the video data 302, which is also referred to herein as a “self-reenactment,” or the realistic representation can have a different identity than the user in the video data 302, which is also referred to herein as a “cross-reenactment.” In some embodiments, the avatar video data 322 can include an avatar that is a representation of an individual who is “filtered” to alter and/or enhance an appearance of the individual. In some other embodiments, the avatar video data 322 can include a stylized representation (e.g., a cartoon, drawing, or other artistic creation) of an individual or character. In such cases, it is assumed herein that the stylized representation does not include stylized animations that dominate the motions of a user driving the avatar, in which case the motions of the user may not be sufficiently discernable to generate a usable signal for authentication purposes. In some embodiments, the identity of the avatar in the avatar video data 322, which can be received as input by the avatar generator 320, which is also referred to herein as a “target identity.” For example, the avatar generator 320 could receive an image or video frame of the target identity. In such cases, the avatar generator 320 generates the avatar video data 322 to include an avatar having the target identity. In addition, the identity of the user in the video data 302 driving the avatar video data 322 is referred to herein as the “driving identity.” It should be understood that the driving identity and the target identity are the same in self-reenactments and different in cross-reenactment.

After the avatar generator 320 generates the avatar video data 322, the server application 146 transmits the avatar video data 322 to the client application 126. As shown, the client application 126 includes an output module 330 that causes the avatar video data 322 to be output to a user of the computing device 120. For example, the avatar video data 322 can be output via one or more display devices. In addition, audio data that is acquired by the microphone 115 can be transmitted from the client application 116 to the client application 126 (e.g., via the server application 146) and output via one or more speaker devices. Although a single output module 330 is shown for illustrative purposes, in some embodiments, functionality of the output module 330 can be implemented in any number of modules, such as separate modules for video and audio output.

In addition to outputting the avatar video data 322, an authentication module 332 authenticates the identity of a user driving an avatar in the avatar video data 322. In some embodiments, authorized users can include a user represented by the avatar (i.e., a self-reenactment) and/or other user(s) who are not represented by the avatar (i.e., a cross-reenactment). For example, a celebrity could control his or her own avatar, as well as register other users who are then authorized to control the avatar.

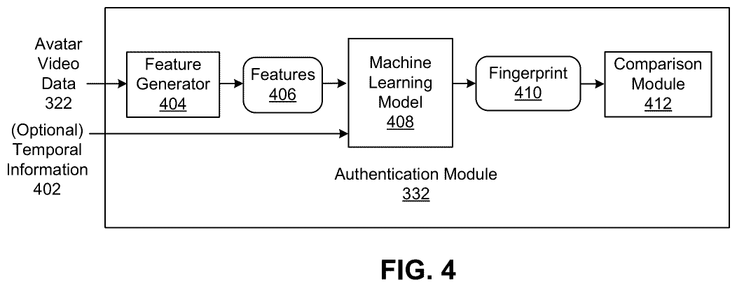

FIG. 4 is a more detailed illustration of the authentication module 332 of FIG. 3, according to various embodiments. As shown, the authentication module 332 includes a feature generator module 404 (“feature generator 404”), a trained machine learning model 408, and a comparison module 412. The feature generator 404 takes the avatar video data 322 as input and outputs features 406 that are generated from the avatar video data 322. Any technically feasible features can be generated in some embodiments. In some embodiments, features can be generated that (1) have minimal dependency on the appearance of the face in the avatar video data 322, (2) reflect the dynamics of expressions of an avatar in the avatar video data 322, and (3) can capture subtle expressions.

For example, in some embodiments, the features 406 can include face performance tracking features such as facial landmarks; face action units; six-dimensional (6D) head poses that include yaw, roll, pitch, and translations; etc. generated for a window of frames of the avatar video data 322. Any sized window of frames can be used in some embodiments. For example, the avatar video data 322 can be broken up into windows that include F frames and are offset by one frame (e.g., [1, F], [2, F+1], etc.). It should be understood that increasing the window size can increase accuracy, but some applications, such as real-time applications, may only be able to process smaller sized windows of frames. As a specific example, a landmark detection technique could be applied to determine the coordinates of facial landmarks on the avatar in each frame within a window of frames, and the Euclidean distances between pairs of facial landmarks can be computed and normalized using a maximum distance between landmarks on a neural expression frame. In such a case, the features 406 can include the pairwise normalized distances between facial landmarks concatenated across frames within the window of frames. As another specific example, the features 406 could include the amplitudes of face action units over frames within a window of frames of the avatar video data 322. As another example, in some embodiments, the features 406 can include physiological signals such as deep motion features that represent learned temporal mannerisms, body gestures, etc. of an avatar in the avatar video data 322. As specific examples, how different muscles of an avatar activate, head poses of the avatar, how often the avatar blinks and raises his or her eyebrows, how much the jaw of the avatar moves during speech, etc. can be generated as the features 406. As yet another example, in some embodiments, the features 406 can include a frequency domain representation of how frequency components change over time for the frames within a window of frames of the avatar video data 322. In such cases, the frequency domain representation can be generated in any technically feasible manner. For example, in some embodiments, the frequency domain representation can be generated by computing a frequency decomposition, such as a Fourier transform, of each frame and then concatenating the frequency decompositions across time. As another example, in some embodiments, the frequency domain representation can be generated by decomposing the frequency composition of how facial landmarks move over time to generate a time series of frequency components.

The machine learning model 408 takes as input the features 406 and, optionally, temporal information 402, and the machine learning model 408 outputs a fingerprint 410 that represents, within an embedding space, motions of the avatar video data 322 for the window of frames used to generate the features 406. In the embedding space, fingerprints generated from avatar video data driven by any given user identity map to points that are relatively close to each other and far from avatar video data driven by other user identities. This is because each individual has unique facial motion idiosyncrasies when speaking and emoting, such as raising the eyebrows more or shaking the head more often. The fingerprint 410 represents such motion and can, therefore, be used to determine user identity. The fingerprint 410 does not rely on the appearance of the avatar, which is generally not a reliable indicator of who is “behind” the avatar. In some embodiments, the temporal information 402 is information associated with the motion, appearance, or other information relating to the identity of a user driving the avatar video data 322, and the temporal information 402 can be generated by the client application 116. For example, the temporal information 402 could be a watermark embedded in video data 302 and then in the avatar video data 322, information that is appended to video data 302 and then to avatar video data 322, or otherwise transmitted from the client application 116 to the client application 126.

In some embodiments, the machine learning model 408 is an artificial neural network. For example, in some embodiments, the machine learning model 408 can be a temporal convolutional neural network (CNN), a transformer, a recurrent neural network (RNN), or the like. In some embodiments, the machine learning model 408 is trained using (1) a data set that includes video data of different user identities as well as self-reenactment and cross-reenactment video data generated by one or more face-reenactment generators from the video data of different user identities; and (2) a dynamic identity embedding contrastive loss (“dynamic contrastive loss”) function that includes a pull term and a push term. In such cases, the pull term pulls together, within an embedding space, fingerprints generated by the machine learning model 408 for avatar video data in which avatars are controlled by the same user identity. The fingerprints are pulled together by increasing, within the embedding space, the similarity between fingerprints for avatar video data that includes avatars driven by video data including the same user identity. The push term pushes apart, within the embedding space, fingerprints generated by the machine learning model 408 for avatar video data in which avatars are controlled by different user identities. The fingerprints are pushed apart by reducing, within the embedding space, the similarity between fingerprints for avatar video data in which avatars are driven by video data including different user identities. Although described herein primarily with respect to the dynamic contrastive loss that includes both a pull term and a push term, in some embodiments, a loss function used to train the machine learning model 408 can include only a pull term or only a push term. In some embodiments, feature data can also be extracted from shuffled video data of various user identities. In such cases, the shuffled video data can be generated by randomly shuffling frames within video data of the various user identities. The shuffled video data can be provided as additional input for generating fingerprints that are pushed away from fingerprints generated from the original video data of the various user identities. In such cases, the push term of the dynamic contrastive loss function can push apart the feature data extracted from the shuffled video data and the original feature data. It should be understood that doing so encourages the machine learning model 408 to rely on motion dynamics of a face or avatar, instead of the appearance of an avatar, when generating a fingerprint for a window of frames of video data. In particular, the shuffled video data helps ensure that the machine learning model 408 learns to rely on the correct temporal progression of frames instead of the shuffled frames in the video of the avatar.

More formally, let [symbol] _{ID}_{₁}_{→ID}_{₂}^{k}(t) denote the embedding produced by the machine learning model 408 for a window of frames starting at time t in a k-th video, of a target identity ID₂ driven by identity ID₁. The pull term of dynamic contrastive loss can be expressed as:

$${N}_{j , I {D}_{1} , I {D}_{2}} ( t ) = {\sum }_{I {D}_{l} , k} {maxs}_{n} ( {𝒞}_{I {D}_{1} \to I {D}_{2}}^{j} ( t ) , {𝒞}_{I {D}_{1} \to I {D}_{l}}^{k} ( n ) ) , \qquad ( 1 )$$

where s(.,.)=e^{-∥ . . . ∥}^{²} is a similarity metric. Intuitively, equation (1) takes two videos, j and k, both driven by ID₁, and given a window of frames starting at time t in the first video, equation (1) looks for the most similar window of frames in the second video. As the driving identity is the same for both videos, equation (1) encourages an embedding where windows of frames that capture a similar expression are closer to each other. Equation (1) is high even if only one window of frames from video k has a similar temporal signature to [symbol] _{ID}_{₁}_{→ID}_{₂}^{j}(t), because even just one occurrence of the same expression is evidence that the driving identity may be the same. Of course, other driving identities may use similar expressions, which is addressed using the push term of the dynamic contrastive loss, described in greater detail below. Additionally, it should be noted that k spans the set of all videos driven by ID₁, and IDₗ spans all identities, including IDₗ=ID₁ and IDₗ=ID₂.

In addition, the push term of dynamic contrastive loss can be expressed as:

$${Q}_{j , I {D}_{1} , I {D}_{2}} ( t ) = {\sum }_{I {D}_{l} \neq I {D}_{1} , k} {maxs}_{n} ( {𝒞}_{I {D}_{1} \to I {D}_{2}}^{j} ( t ) , {𝒞}_{I {D}_{l} \to I {D}_{2}}^{k} ( n ) ) , \qquad ( 2 )$$

where, similarly to equation (1), for a window of frames in video j, equation (2) looks for the most similar window of frames in video k. However, the two videos share the same target identity, but are driven by different identities: the goal is for videos driven by identities different from ID₁ to be pushed away from those driven by ID₁, including videos where ID₁ is the target identity. It should be noted that ID₂ spans all identities, including ID₂=ID₁ and ID₂=ID₁.

It should be noted that the machine learning model 408 could still learn to rely on static expressions, such as a snapshot of the person smiling, rather than the temporal progression of expression leading to, or following, the smile. To encourage the machine learning model 408 to instead learn from temporal dynamics, an additional term can be used during training:

$${R}_{j , I {D}_{1} , I {D}_{2}} ( t ) = {\sum }_{I {D}_{l} , k} {maxs}_{n} ( {𝒞}_{I {D}_{1} \to I {D}_{2}}^{j} ( t ) , {\tilde{𝒞}}_{I {D}_{1} \to I {D}_{l}}^{k} ( n ) ) , \qquad ( 3 )$$

where [symbol] _{ID}_{₁}_{→ID}_{ₗ}^{k} denotes a version of the clip [symbol] _{ID}_{₁}_{→ID}_{ₗ}^{k} from equation (1) with randomly shuffled frame ordering. Such time-shuffled versions of the clips driven by ID₁ should be pushed away from the un-shuffled self-reenactment clips of ID₁, meaning that the driving identity of the time-shuffled clips is regarded as different from ID₁. In other words, video clips in the learned embedding space should be pulled together only when the temporal facial dynamics are characteristic of ID₁.

Combining equations (1)-(3), the probability that the embedding vector [symbol] _{ID}_{₁}_{→ID}_{₂}^{j}(t) lies close to the embedding vectors for all video clips driven by ID₁ and far from all the videos driven by others can be written as:

$${p}_{j , I {D}_{1} , I {D}_{2}} ( t ) = \frac{{N}_{j , I {D}_{1} , I {D}_{2}} ( t )}{{N}_{j , I {D}_{1} , I {D}_{2}} ( t ) + {Q}_{j , I {D}_{1} , I {D}_{2}} ( t ) + {R}_{j , I {D}_{1} , I {D}_{2}} ( t )} , \qquad ( 3 )$$

and the complete dynamic contrastive loss can be written as:

$$ℒ = {\sum }_{j , I {D}_{1} , I {D}_{2} , t} - log ( {p}_{j , I {D}_{1} , I {D}_{2}} ( t ) ) . \qquad ( 4 )$$

The comparison module 412 compares the fingerprint 410 generated by the machine learning model 408 with stored fingerprints of users who are authorized to drive the avatar video data 322. In some embodiments, the stored fingerprints can be generated during an onboarding process in which each authorized user records video(s) of him or herself, the recorded video(s) are processed via an avatar generator to generate self-reenactment video(s), and the self-reenactment video(s) are processed via the feature generator 404 and the machine learning model 408 to generate a fingerprint of the authorized user. In some embodiments, the onboarding process also includes determining whether the video(s) are of a live person, as opposed to recorded video(s) that are played back. In such cases, a check for liveliness can be performed in any technically feasible manner, such as based on the pulse of a face, motion magnification, prompting a user to read a displayed sentence, and/or the like.

If the fingerprint 410 matches any fingerprint associated with a user who is authorized to drive the avatar video data 322, then the user is authenticated. In some embodiments, a match occurs when the fingerprint 410 is within a threshold distance of one of the stored fingerprints associated with authorized users. In such cases, any technically feasible measure of distance, such as L2 distance, can be used. On the other hand, if the fingerprint 410 does not match the fingerprint associated with any authorized user, then the user is not authenticated.

Returning to FIG. 3, when the user is not authenticated by the comparison module 412, the server application 146 transmits a notification to the client application 126 that the identity of the user has not been authenticated. In some embodiments, the output module 330 of the client application 126 causes the notification to be output to the other user. For example, in some embodiments a notification can be displayed along with the avatar video data 322 that is received from the server application 146. In such cases, any technically feasible form of notification can be displayed, such as a text notification, warning sign, a red light, etc. Although described herein primarily with respect to transmitting and outputting a notification when the user is not authenticated, in some embodiments, a notification can additionally or alternatively be transmitted and output when the user is authenticated. For example, in some embodiments, a text notification, checkmark, green light, etc. can be displayed as the notification that the user has been authenticated.

Although described above with respect to transmitting a notification as a reference example, in some embodiments, other remedial actions can be taken in addition to, or in lieu of, transmitting a notification if a user is not authenticated by the comparison module 412. For example, in some embodiments, the server application 146 does not transmit the avatar video data 322 to the client application 126 if the user is not authenticated by the comparison module 412. As another example, in some embodiments, the server application 146 stops permitting the user to control the avatar in the avatar video data 322 if the user is not authenticated by the comparison module 412.

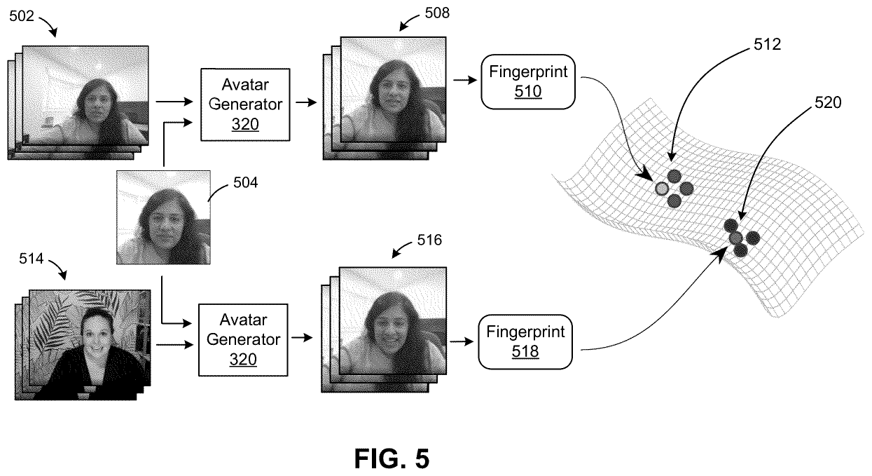

FIG. 5 illustrates how to authenticate exemplar users that drive avatars, according to various embodiments. As shown, a video 502 of a first user identity and a video 514 of a second user identity are driving videos 508 and 516, respectively, that include avatars of the first user identity. In particular, the video 502 of the first user identity and the video 514 of the second user identity are input, along with a target identity 504 that is the first user identity, into the avatar generator 320. Given such inputs, the avatar generator 320 outputs the avatar videos 508 and 516 that include avatars of the first user identity.

The first user identity and the second user identity that are driving avatars in the avatar videos 508 and 516 can be determined from the avatar videos 508 and 516 using fingerprints 510 and 518 that are generated by processing the avatar videos 508 and 516, respectively, using the feature generator 404 and the machine learning model 408, described above in conjunction with FIG. 4. Illustratively, within an embedding space, fingerprints for avatar videos driven by one user identity (e.g., fingerprints 512) fall close to each other and far away from fingerprints driven by other user identities (e.g., fingerprints 520), regardless of the appearance of the avatars (e.g., avatars within the avatar videos 508 and 516).

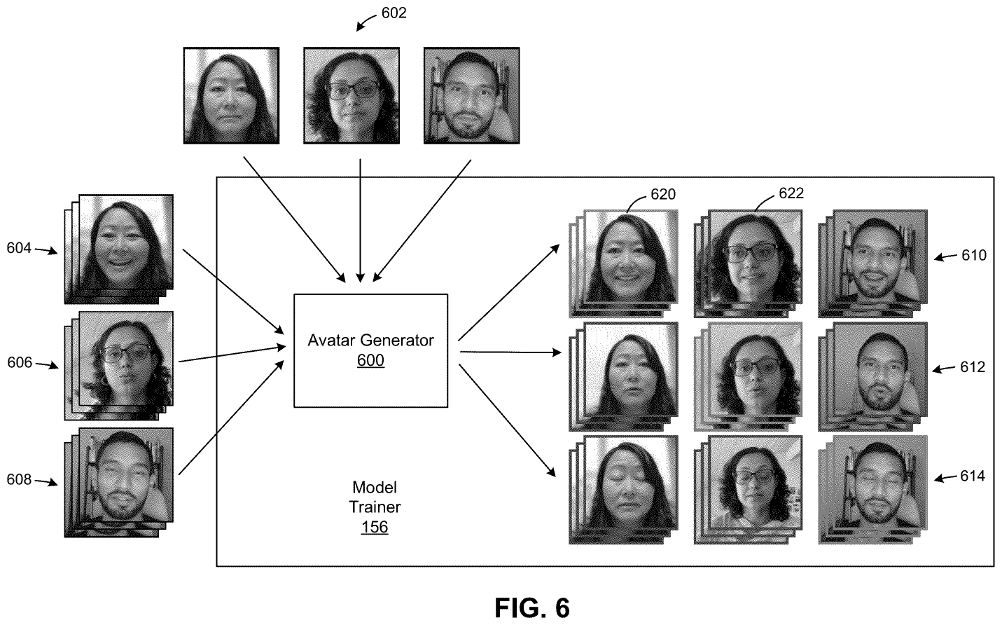

FIG. 6 illustrates how exemplar training data is generated for training the machine learning model 408 of FIG. 4, according to various embodiments. As shown, given (1) videos 604, 606, and 608 of different user identities, and (2) images 602 of target user identities, as input, the model trainer 156 processes the videos 604, 606, and 608 using an avatar generator 600, which can be similar to avatar generator 320, to generate training data that sets 610, 612, and 614 of videos, each of which includes self-reenactment videos (e.g., video 620) generated via one or more face-reenactment generators by using the videos 604, 606, and 608 to drive the avatar shaving the same identity and cross-reenactment videos (e.g., video 622) generated by using the videos 604, 606, and 608 to drive avatars having different identities than the user identities in the videos 604, 606, and 608, respectively. To avoid a combinatorial explosion of generated videos, for all pairs of identities IDᵢ and IDⱼ, when IDⱼ is used as the target identity, a number n of videos of identities IDᵢ can be randomly selected to generate n cross-enactment videos, {IDᵢ^{k}→IDⱼ}_{k={1, . . . n}}.

Feature representations of avatars in the sets 610, 612, and 614 of videos can then be generated, and the machine learning model 408 can be trained using the dynamic contrastive loss function that pulls together, within an embedding space, fingerprints generated by the machine learning model 408 for avatar video data in which avatars are controlled by the same user identity, and pushes apart, within the embedding space, fingerprints generated by the machine learning model 408 for avatar video data in which avatars are controlled by different user identities.

Although three videos 604, 606, and 608 are shown for illustrative purposes, in some embodiments, video can be captured of any number of user identities. In some embodiments, to encourage natural performances in a realistic setting, users can be recorded while videoconferencing with each other to generate videos such as the videos 604, 606, and 608. In such cases, minimal instructions can be given on how to set up the videoconferences, allowing for the variability that can be expected in natural settings and the data to be as challenging as real-life scenarios. For example, backgrounds in the videoconferences can include various degrees of clutter, and the available bandwidth during the videoconferences can affect the video compression. In some embodiments, to generate videos such as the videos 604, 606, and 608, users can be recorded talking in both scripted and free-form settings. In such cases, in the free-form settings, users are given only general guidance on topics to discuss. For example, in a free-form setting, users on a videoconference call could alternate between asking and answering a number of predefined questions. To further create natural interactions, users who are listening can be encouraged to actively engage with users who are speaking (e.g., by nodding or smiling), while remaining silent. By contrast, in the scripted monologues, users can perform a number of predefined short utterances that include a few (e.g., two or three) sentences each. To avoid inducing unnatural expressions, specific emotions are not prescribed for each utterance.

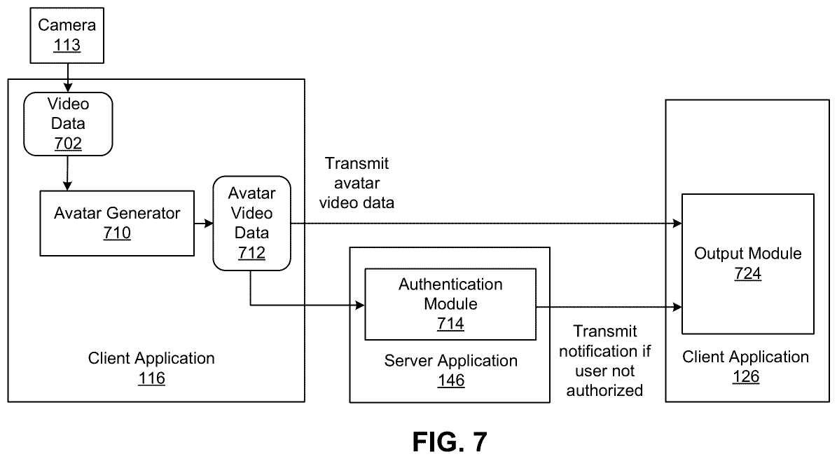

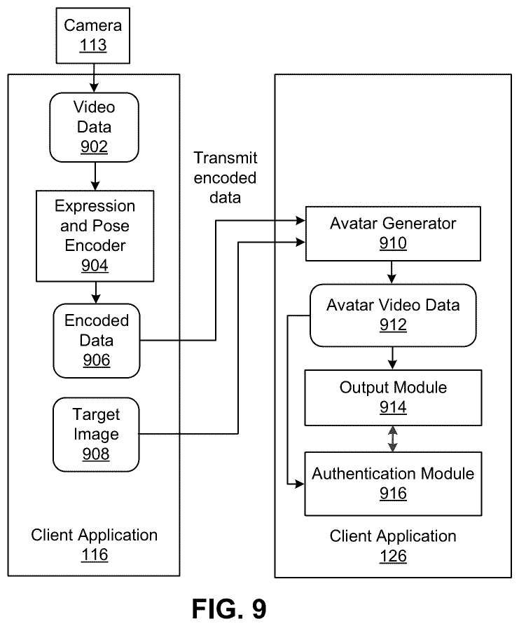

FIG. 7 is a more detailed illustration of the client applications 116 and 126 and the server application 146 of FIG. 1, according to various other embodiments. As shown, in some embodiments, the client application 116 includes an avatar generator 710 that generates avatar video data 712. The client application 116 transmits the avatar video data 712 to the client application 126 for output via an output module 724. In addition, the client application 116 uploads the avatar to the server application 146, which includes an authentication module 714. The avatar generator 710, the authentication module 714, and the output module 724 are similar to the avatar generator 320, the authentication module 322, and the output module 330 that are described above in conjunction with FIG. 3. However, the authentication module 714 is implemented in the server application 146 rather than the client application 126. In some embodiments, each module, such as the avatar generator 710 and the authentication module 714, can be implemented in the client application 116, the server application 146, or the client application 126, depending on various considerations such as computational resources available on the computing device 110, how much uploading bandwidth is available, etc. Some other implementations of the modules are described below in conjunction with FIG. 9.

The server application 146 brokers a connection between the client applications 116 and 126 by, for example, performing handshaking and a hand off. In addition, the server application 146 serves as a sidecar application that authenticates that the user driving the avatar video data 712 is authorized to control the avatar in the avatar video data 712 based on motions of the avatar. In some embodiments, to authenticate the user driving the avatar video data 712, the authentication module 830 computes features for windows of frames from the avatar video data 712, processes the features using a trained machine learning model to generate one or more fingerprints, and compares the one or more fingerprints to stored fingerprints of authorized users. When the identity of the user is not authenticated by the authentication module 714, the server application 146 transmits a notification to the client application 126 that the user has not been authenticated. In some embodiments, the output module 724 of the client application 126 causes the notification to be output to the other user. For example, in some embodiments, a notification can be displayed along with the avatar video data 712 that is received from the server application 146. In such cases, any technically feasible form of notification can be displayed, such as a text notification, warning sign, a red light, etc. Although described herein primarily with respect to transmitting and outputting a notification when a user is not authenticated, in some embodiments, a notification can additionally or alternatively be transmitted and output when a user is authenticated. For example, in some embodiments, a text notification, checkmark, green light, etc. can be displayed as the notification that a user has been authenticated. Additionally or alternatively, in some embodiments, the server application 146 can take any other technically feasible remedial actions if the user is not authenticated, such as the remedial actions described above in conjunction with FIG. 5.

In some embodiments, to protect the privacy of the user in the video data 702 and/or due to limited uploading bandwidth, the feature generator 404 and the machine learning model 408 can be implemented in the client application 116. In such cases, the client application 116 can upload a fingerprint to the server application 146, and a comparison module (similar to comparison module 412) in the server application 146 can authenticate the user by comparing the uploaded fingerprint with stored fingerprints of authorized users.

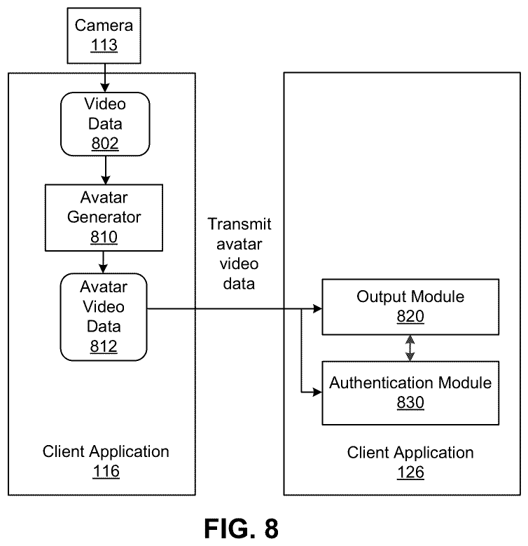

FIG. 8 is a more detailed illustration of the client applications 116 and 126 of FIG. 1, according to various other embodiments. As shown, in some embodiments, the client application 116 includes an avatar generator 810, and the client application 126 includes an output module 820 and an authentication module 830. The avatar generator 810, output module 820, and authentication module 830 are similar to the avatar generator 320, output module 330, and authentication module 332, described above in conjunction with FIG. 3. However, the server application 146 is not required because the client application 116 includes the avatar generator 810 that generates avatar video data 812 that is then transmitted to the client application 126.

The client application 126 includes the authentication module 830 that determines whether the avatar video data 812 is being driven by an authorized user based on motions of an avatar in the avatar video data 812. In some embodiments, the authentication module 830 computes features for windows of frames from the avatar video data 812, processes the features using a trained machine learning model to generate one or more fingerprints, and compares the one or more fingerprints to stored fingerprints of authorized users. The stored fingerprints of authorized users can be obtained in any technically feasible manner. For example, the stored fingerprints could be transmitted to the client application 126 at an earlier time. As another example, the stored fingerprints could have previously been uploaded to a blockchain, from which the client application 126 downloaded those fingerprints.

If the one or more fingerprints do not match the fingerprint of any authorized user, then the user is not authenticated by the authentication module 830. In such a case, the output module 820 of the client application 126 causes a notification that the user has not been authenticated to be output to a user of the client device 120, similar to the description above in conjunction with FIG. 7. Additionally or alternatively, in some embodiments, the client application 126 can take any other technically feasible remedial actions if the user is not authenticated based on the matching of fingerprints, similar to the description above in conjunction with FIG. 7.

FIG. 9 is a more detailed illustration of the client applications of FIG. 1, according to various other embodiments. As shown, in some embodiments, the client application 116 includes an expression and pose encoder 904, and the client application 126 includes an avatar generator 910, an output module 914, and an authentication module 916. The output module 914 and the authentication module 916 are similar to the output module 330 and authentication module 332, described above in conjunction with FIG. 3. However, the server application 146 is not required.

As shown, the expression and pose encoder 904 encodes expression and head pose information within video data 902, which is captured by the camera 113, as encoded data 906. The expression and pose encoder 904 can perform any technically feasible encoding, including known encoding techniques, to encode the video data 902. The client application 116 transmits, to the client application 126, the encoded data 906 and a target image 908 that indicates the target identity of an avatar. For example, in some embodiments, the target image 908 can be a single video frame that indicates the target identity.

Given the encoded data 906 and the target image 908, the avatar generator 910 generates avatar video data 912 that includes an avatar that has the identity indicated by the target image 908 and moves according to the expression and head pose information encoded in the encoded data 906. The avatar video data 912 is output to a user via the output module 914. In addition, the authentication module 916 determines whether the avatar video data 912 is driven by an authorized user based on motions of the avatar in the avatar video data 912. In some embodiments, the authentication module 916 computes features for windows of frames from the avatar video data 912, processes the features using a trained machine learning model to generate one or more fingerprints, and compares the one or more fingerprints to stored fingerprints of authorized users. The stored fingerprints of authorized users can be obtained in any technically feasible manner. For example, the stored fingerprints could be transmitted to the client application 126 at an earlier time. As another example, the stored fingerprints could have previously been uploaded to a blockchain, from which the client application 126 downloaded those fingerprints.

If the one or more fingerprints do not match the fingerprint of any authorized user, then the user is not authenticated by the authentication module 916. In such a case, the output module 914 of the client application 126 causes a notification that the user has not been authenticated to be output to a user of the client device 120, similar to the description above in conjunction with FIG. 7. Additionally or alternatively, in some embodiments, the client application 126 can take any other technically feasible remedial actions if the user is not authenticated based on the matching of fingerprints, similar to the description above in conjunction with FIG. 7.

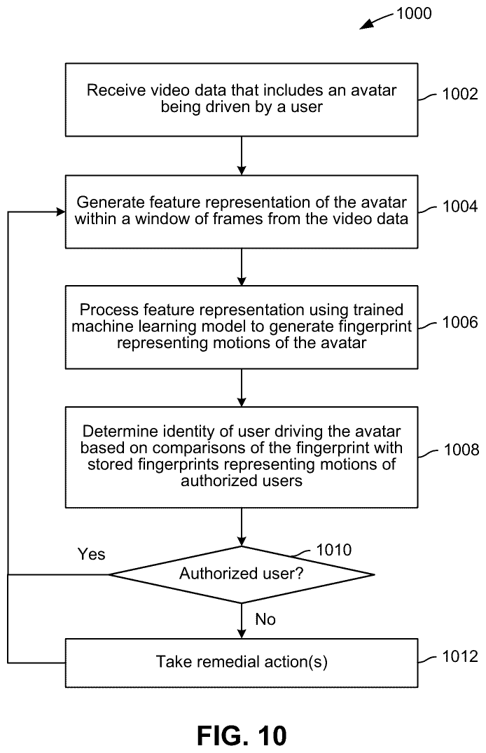

FIG. 10 is a flow diagram of method steps for authenticating a user during a computer-mediated interaction, according to various embodiments. Although the method steps are described in conjunction with the systems of FIGS. 1-9, persons skilled in the art will understand that any system configured to perform the method steps in any order falls within the scope of the present embodiments.

As shown, a method 1000 begins at step 1002, where the authentication module 332 receives video data that includes an avatar being driven by a user. In some embodiments, the video data can be generated by a client application (e.g., client application 116 or 126) or a server application (e.g., server application 146) that processes captured video data of the user using a generative machine learning model to generate the video data that includes the avatar.

At step 1004, the authentication module 332 generates feature data for the avatar within a window of frames from the video data. Any technically feasible feature data can be generated in some embodiments. Further, a window of frames of any suitable size can be used in some embodiments. As described, using a larger window size can increase accuracy, but some applications, such as real-time applications, may only be able to process smaller sized windows of frames. In some embodiments, the feature data can include pairwise normalized distances between facial landmarks concatenated across frames within the window of frames. Other examples of feature data include feature data based on face action units; facial landmarks; six-dimensional (6D) head poses that include yaw, roll, pitch, and translations; deep motion features that represent learned temporal mannerisms or body gestures; a frequency domain representation of how frequency components change over time for the frames within a window of frames; and/or the like.

At step 1006, the authentication module 332 processes the feature representation using a trained machine learning model to generate a fingerprint representing motions of the avatar. In some embodiments, the machine learning model is trained using (1) a data set that includes video data of different user identities as well as self-reenactment and cross-reenactment video data generated by one or more face-reenactment generators from the video data of different user identities, and (2) a dynamic contrastive loss function that includes a pull term and a push term, as discussed in greater detail below in conjunction with FIG. 12.

At step 1008, the authentication module 332 determines an identity of the user driving the avatar based on comparisons of the fingerprint generated at step 1006 with stored fingerprints representing motions of authorized users. In some embodiments, the user is determined to be one of the authorized users if the fingerprint is within a threshold distance of one of the stored fingerprints representing motions of authorized users. In such cases, any technically feasible measure of distance, such as L2 distance, can be used.

At step 1010, if the user is an authorized user, then the method 1000 returns to step 1002, where the authentication module 332 receives additional video data to process, assuming the computer-mediated interaction continues and the user driving the avatar needs to be authenticated throughout the computer-mediated interaction.

On the other hand, if the user is not an authorized user, then at step 1012, the authentication module 332 takes one or more remedial actions. In some embodiments, the remedial actions can include transmitting and/or displaying a notification that is displayed to another user, not transmitting an avatar to a client application, preventing the user from controlling the avatar, a combination thereof, etc.

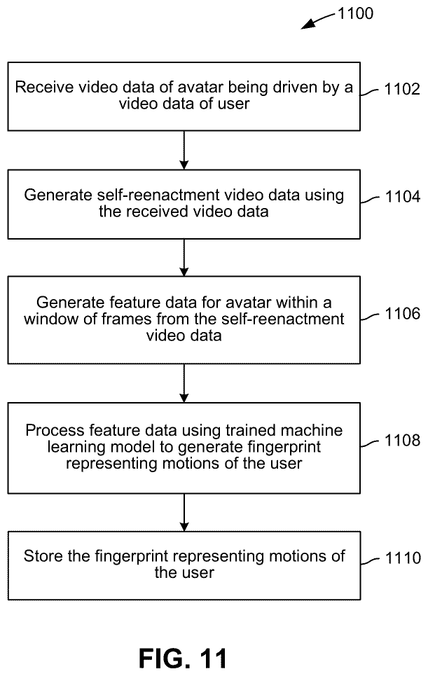

FIG. 11 is a flow diagram of method steps for generating a fingerprint that represents motions of a user during an onboarding process. Although the method steps are described in conjunction with the systems of FIGS. 1-9, persons skilled in the art will understand that any system configured to perform the method steps in any order falls within the scope of the present embodiments.

As shown, a method 1100 begins at step 1102, where the authentication module 332 receives video data that includes a user having a user identity. In some embodiments, the authentication module 332 can also determine whether the received video data includes a live person, as opposed to being recorded video data that is played back. In such cases, the authentication module 332 can perform a check for liveliness in any technically feasible manner, such as based on the pulse of a face, motion magnification, prompting a user to read a displayed sentence, and/or the like.

At step 1104, the authentication module 332 generates self-reenactment video data using the received video data. In some embodiments, the self-reenactment video data can be generated by inputting (1) frames from the received video data, and (2) the user identity as a target identity into a generative machine learning model that outputs frames of the self-reenactment video data. Although described herein primarily with respect to generating self-reenactment video data using received video data, in some embodiments, the received video data can be used directly, without generating self-reenactment video data, i.e., step 1104 is optional.

At step 1106, the authentication module 332 generates feature data for an avatar within a window of frames from the self-reenactment video data. In some embodiments, the feature data can include pairwise normalized distances between facial landmarks concatenated across frames within the window of frames. Other examples of feature data include feature data based on face action units; facial landmarks; six-dimensional (6D) head poses that include yaw, roll, pitch, and translations; deep motion features that represent learned temporal mannerisms or body gestures; a frequency domain representation of how frequency components change over time for the frames within a window of frames; and/or the like.

At step 1108, the authentication module 332 processes the feature data using a trained machine learning model to generate a fingerprint representing motions of the user. Step 1108 is similar to step 1006 of the method 1000, described above in conjunction with FIG. 10, except the feature data generated from the self-reenactment video data is being processed to generate the fingerprint.

At step 1110, the authentication module 332 stores the fingerprint representing motions of the user. Fingerprints generated from video data of users can then be compared with the stored fingerprint for authentication purposes, as described above in conjunction with FIG. 10.

FIG. 12 is a flow diagram of method steps for training a machine learning to generate fingerprints that represent motions of users, according to various embodiments. Although the method steps are described in conjunction with the systems of FIGS. 1-9, persons skilled in the art will understand that any system configured to perform the method steps in any order falls within the scope of the present embodiments.

As shown, a method 1200 begins at step 1202, where the model trainer 156 receives video data for multiple users. In some embodiments, the video data can be captured of any number of user identities talking in both scripted and free-form settings. In such cases, to encourage a natural performance in a realistic setting, the users can be recorded while videoconferencing with each other, as described above in conjunction with FIG. 6.

At step 1204, the model trainer 156 generates self-reenactment video data and cross-reenactment video data using the received video data. In some embodiments, the self-reenactment video data and the cross-reenactment video data can be generated by inputting (1) frames from the video data for the multiple users, and (2) the same user identity and other identities as the target identity into one or more generative machine learning models that output frames of the self-reenactment video data and the cross-reenactment video data.

At step 1206, the model trainer 156 generates shuffled video data using the received video data. The shuffled video data can be generated by randomly shuffling frames within the video data for each user. As described, the shuffled video data can be provided as additional input for generating fingerprints that are pushed away from fingerprints generated from the received video data, thereby encouraging a trained machine learning model to rely on sequences of motion, rather than a collection of expressions, when generating a fingerprint for a window of frames of video data.

At step 1208, the model trainer 156 generates feature data for the avatars in the received video data, the self-reenactment video data, the cross-reenactment video data, and the shuffled video data. In some embodiments, the feature data can include pairwise normalized distances between facial landmarks concatenated across frames within windows of frames from the received video data, the self-reenactment video data, and the cross-reenactment video data. Other examples of feature data include feature data based on face action units; facial landmarks; six-dimensional (6D) head poses that include yaw, roll, pitch, and translations; deep motion features that represent learned temporal mannerisms or body gestures; frequency domain representations of how frequency components change over time for the frames within windows of frames from the received video data, the self-reenactment video data, and the cross-reenactment video data; and/or the like.

At step 1210, the model trainer 156 trains a machine learning model to generate fingerprints that represent motions using the feature data generated at step 1208 and a dynamic contrastive loss. In some embodiments, the dynamic contrastive loss includes (1) a pull term that pulls together, within an embedding space, fingerprints for avatars are controlled by the same identity; and (2) a push term that pushes apart, within the embedding space, fingerprints for avatars are controlled by different user identities, including fingerprints for avatars controlled by a particular user identity and fingerprints for the same avatars in shuffled video data, as described above in conjunction with FIG. 4. Although described herein primarily with respect to the dynamic contrastive loss that includes both a pull term and a push term, in some embodiments, a loss function used to train the machine learning model can include only a pull term or only a push term. In some embodiments, any technically feasible training technique, such as backpropagation with gradient descent or a variation thereof, can be used to train the machine learning model at step 1206.

In sum, techniques are disclosed for authenticating user identities during computer-mediated interactions. Given video data that includes an avatar being driven by a user, an authorization module of a client or server application generates feature data for the avatar within a window of frames. The authorization module processes the feature data using a trained machine learning model to generate a fingerprint representing motions of the avatar within the window of frames, regardless of the appearance of the avatar, which is generally not a reliable indicator of who is “behind” the avatar. The authorization module authenticates the identity of the user driving the avatar by comparing the fingerprint representing motions of the avatar with stored fingerprints representing motions of users who are authorized to drive the avatar. The user is an authorized user if the fingerprint representing motions of the avatar is within a threshold distance of one of the stored fingerprints representing motions of authorized users. In some embodiments, the machine learning model used to generate the fingerprint can be trained using (1) training data that includes self-reenactment video data in which avatars having particular identities are driven by video data of users having the same identities and cross-reenactment videos in which avatars having particular identities are driven by video data of users having different user identities; and (2) a dynamic contrastive loss function that pulls together, within an embedding space, fingerprints generated by the machine learning model for video data in which avatars are controlled by users having the same identity, and pushes apart, within the embedding space, fingerprints generated by the machine learning model for video data in which avatars are controlled by users having different identities.

At least one technical advantage of the disclosed techniques relative to the prior art is that the disclosed techniques enable the identities of users who control avatars during computer-mediated interactions to be authenticated. The authentication of user identities can improve security, trust, and safety during computer-mediated interactions. These technical advantages represent one or more technological improvements over prior art approaches.

1. In some embodiments, a computer-implemented method for authenticating users comprises generating a first fingerprint that represents one or more motions of a first avatar that is driven by a first user, and determining an identity of the first user based on the first fingerprint and a second fingerprint associated with the first user.

2. The computer-implemented method of clause 1, wherein determining the identity of the first user comprises determining that a distance between the first fingerprint and the second fingerprint is less than a predefined threshold.

3. The computer-implemented method of clauses 1 or 2, further comprising generating the second fingerprint based on a second avatar that is driven by the first user.

4. The computer-implemented method of any of clauses 1-3, wherein the first fingerprint is generated during a computer-mediated interaction between a plurality of users that includes the first user.

5. The computer-implemented method of any of clauses 1-4, wherein generating the first fingerprint comprises performing one or more operations to generate feature data based on the first avatar, and processing the feature data via a trained machine learning model to generate the first fingerprint.

6. The computer-implemented method of any of clauses 1-5, wherein the feature data includes at least one of one or more distances between facial landmarks, one or more facial action units, or one or more frequency components.

7. The computer-implemented method of any of clauses 1-6, further comprising performing one or more operations to train the machine learning model based on at least one of video or audio data in which a plurality of users are represented by (i) a plurality of avatars of the plurality of users, and (ii) a plurality of avatars of other users.

8. The computer-implemented method of any of clauses 1-7, further comprising performing one or more operations to train the machine learning model based on video data in which a plurality of frames are shuffled, wherein the plurality of frames include at least one avatar that represents at least one user.

9. The computer-implemented method of any of clauses 1-8, further comprising performing one or more operations to train the machine learning model based on a loss function that at least one of (i) decreases distances between fingerprints generated via the machine learning model for at least one of video data or audio data in which a plurality of avatars are controlled by a same user, or (ii) increases distances between fingerprints generated via the machine learning model for at least one of video data or audio data in which a plurality of avatars are controlled by different users.

10. The computer-implemented method of any of clauses 1-9, wherein the identity of the first user is further determined based on temporal information generated by a computing device that generates at least one of video data or audio data used to generate the first avatar.

11. The computer-implemented method of any of clauses 1-10, wherein the first avatar is included in at least one of video data or an extended reality (XR) environment.

12. The computer-implemented method of any of clauses 1-11, wherein the first avatar comprises at least one of an avatar of a face, a filtered face of the first user, a full-body avatar, a three-dimensional (3D) avatar, or a voice avatar.

13. In some embodiments, one or more non-transitory computer-readable media store program instructions that, when executed by at least one processor, cause the at least one processor to perform the steps of generating a first fingerprint that represents one or more motions of a first avatar that is driven by a first user, and determining an identity of the first user based on the first fingerprint and a second fingerprint associated with the first user.

14. The one or more non-transitory computer-readable media of clause 13, wherein determining the identity of the first user comprises determining that a distance between the first fingerprint and the second fingerprint is less than a predefined threshold.

15. The one or more non-transitory computer-readable media of clauses 13 or 14, wherein the instructions, when executed by the at least one processor, further cause the at least one processor to perform the step of generating the second fingerprint based on a second avatar that is driven by the first user.

16. The one or more non-transitory computer-readable media of any of clauses 13-15, wherein the first fingerprint is generated during a teleconference between the first user and one or more other users.

17. The one or more non-transitory computer-readable media of any of clauses 13-16, wherein generating the first fingerprint comprises performing one or more operations to generate feature data based on the first avatar, and processing the feature data via a trained machine learning model to generate the first fingerprint.

18. The one or more non-transitory computer-readable media of any of clauses 13-17, wherein the feature data includes at least one of one or more distances between facial landmarks, one or more facial action units, or one or more frequency components.

19. The one or more non-transitory computer-readable media of any of clauses 13-18, wherein the steps of generating the first fingerprint and determining the identity of the first user are performed by an application running on either a client computing device or a server computing device.

20. In some embodiments, a system comprises one or more memories storing instructions, and one or more processors that are coupled to the one or more memories and, when executing the instructions, are configured to generate a first fingerprint that represents one or more motions of a first avatar that is driven by a first user, and determine an identity of the first user based on the first fingerprint and a second fingerprint associated with the first user.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for authenticating users, the method comprising:
generating a first fingerprint that represents one or more motions of a first avatar that is driven by a first user; and
determining an identity of the first user based on the first fingerprint and a second fingerprint associated with the first user.

2. The computer-implemented method of claim 1, wherein determining the identity of the first user comprises determining that a distance between the first fingerprint and the second fingerprint is less than a predefined threshold.

3. The computer-implemented method of claim 1, further comprising generating the second fingerprint based on a second avatar that is driven by the first user.

4. The computer-implemented method of claim 1, wherein the first fingerprint is generated during a computer-mediated interaction between a plurality of users that includes the first user.

5. The computer-implemented method of claim 1, wherein generating the first fingerprint comprises:
performing one or more operations to generate feature data based on the first avatar; and
processing the feature data via a trained machine learning model to generate the first fingerprint.

6. The computer-implemented method of claim 5, wherein the feature data includes at least one of one or more distances between facial landmarks, one or more facial action units, or one or more frequency components.

7. The computer-implemented method of claim 5, further comprising performing one or more operations to train the machine learning model based on at least one of video or audio data in which a plurality of users are represented by (i) a plurality of avatars of the plurality of users, and (ii) a plurality of avatars of other users.

8. The computer-implemented method of claim 5, further comprising performing one or more operations to train the machine learning model based on video data in which a plurality of frames are shuffled, wherein the plurality of frames include at least one avatar that represents at least one user.

9. The computer-implemented method of claim 5, further comprising performing one or more operations to train the machine learning model based on a loss function that at least one of (i) decreases distances between fingerprints generated via the machine learning model for at least one of video data or audio data in which a plurality of avatars are controlled by a same user, or (ii) increases distances between fingerprints generated via the machine learning model for at least one of video data or audio data in which a plurality of avatars are controlled by different users.

10. The computer-implemented method of claim 1, wherein the identity of the first user is further determined based on temporal information generated by a computing device that generates at least one of video data or audio data used to generate the first avatar.

11. The computer-implemented method of claim 1, wherein the first avatar is included in at least one of video data or an extended reality (XR) environment.

12. The computer-implemented method of claim 1, wherein the first avatar comprises at least one of an avatar of a face, a filtered face of the first user, a full-body avatar, a three-dimensional (3D) avatar, or a voice avatar.

13. One or more non-transitory computer-readable media storing program instructions that, when executed by at least one processor, cause the at least one processor to perform the steps of:
generating a first fingerprint that represents one or more motions of a first avatar that is driven by a first user; and
determining an identity of the first user based on the first fingerprint and a second fingerprint associated with the first user.

14. The one or more non-transitory computer-readable media of claim 13, wherein determining the identity of the first user comprises determining that a distance between the first fingerprint and the second fingerprint is less than a predefined threshold.

15. The one or more non-transitory computer-readable media of claim 13, wherein the instructions, when executed by the at least one processor, further cause the at least one processor to perform the step of generating the second fingerprint based on a second avatar that is driven by the first user.

16. The one or more non-transitory computer-readable media of claim 13, wherein the first fingerprint is generated during a teleconference between the first user and one or more other users.

17. The one or more non-transitory computer-readable media of claim 13, wherein generating the first fingerprint comprises:
performing one or more operations to generate feature data based on the first avatar; and
processing the feature data via a trained machine learning model to generate the first fingerprint.

18. The one or more non-transitory computer-readable media of claim 17, wherein the feature data includes at least one of one or more distances between facial landmarks, one or more facial action units, or one or more frequency components.

19. The one or more non-transitory computer-readable media of claim 13, wherein the steps of generating the first fingerprint and determining the identity of the first user are performed by an application running on either a client computing device or a server computing device.

20. A system, comprising:
one or more memories storing instructions; and
one or more processors that are coupled to the one or more memories and, when executing the instructions, are configured to:
generate a first fingerprint that represents one or more motions of a first avatar that is driven by a first user, and
determine an identity of the first user based on the first fingerprint and a second fingerprint associated with the first user.
